(19) United States
(12) Patent Application Publication
(10) Pub. No.: US 2011/0038386 A1
(43) Pub. Date: Feb. 17, 2011

(54) TRANSMISSION OF A VIDEO STREAM CODED BY HIERARCHICAL CODING

(75) Inventors: Bertrand Berthelot, Bourgbarre (FR); Stéphanie Relier, Domloup (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/989,706

(22) PCT Filed: Apr. 21, 2009
(86) PCT No.: PCT/FR09/50742

§ 371 Date: Oct. 26, 2010

(30) Foreign Application Priority Data
Apr. 29, 2008 (FR) 0852902

(51) Int. Cl. H04L 29/02

(52) U.S. Cl. 370/474; 375/240.01

(57) ABSTRACT

A video stream is produced coded in a hierarchical manner in the form of a base stream and of an enhancement stream heightened along one dimension and transmitted via a packet transmission network according to a determined transmission protocol. At the level of a transmission entity, a first series is ordered according to a first order of coded packets, from an encoder. A series of packets is obtained, coded according to a second order by grouping said coded packets into groups of N packets, by traversing in the first order the coded packets of the first series, said N packets of one and the same group either all relating to the base stream or all relating to the enhancement stream. Thereafter, packets to be transmitted are composed, said packets comprising respectively as payload the groups of the series of coded packets.

The present invention relates to the transmission of video-type streams via an IP transmission network, and more specifically in the case where the video-type streams are coded according to a hierarchical coding.

In order to be transmitted, video and audio data are generally compressed according to a compression protocol such as, for example, according to the MPEG-4 AVC/H.264 protocol (MPEG standing for “moving pictures expert group”, and AVC standing for “advanced video coding”). Data compressed in this way can then be transmitted according to the MPEG-2 TS (transport stream) protocol (ISO/IEC 13818-1), defined by RFC2250, in IP (internet protocol) packets through an IP transmission network.

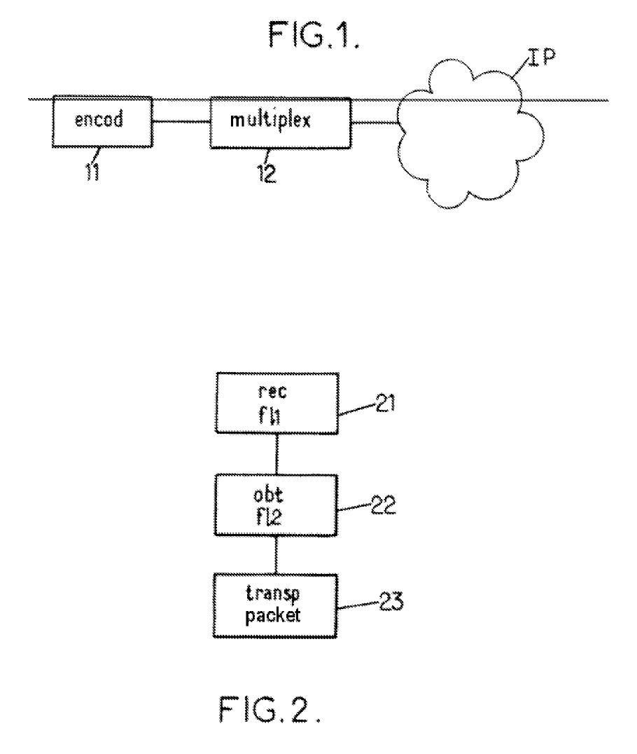

FIG. 1 illustrates an architecture of the prior art which allows for such an audio and video data stream processing.

Firstly, the data stream is encoded in an encoder 11 according to the MPEG-4 AVC protocol. The encoder 11 thus supplies at its output PES (packetized elementary stream) type packets. A PES packet comprises a header field and a payload. The header field makes it possible to identify an elementary stream type to which the corresponding packet belongs. An elementary stream may be of video or audio type, or even may correspond to a stream relating to subtitles for example. A set of elementary streams forms a program.

The PES packets encoded in this way at the output of the encoder are multiplexed, in a multiplexer 12, according to the MPEG-2 TS protocol in order to supply packets, called TS packets, all of the same length, which can easily be encapsulated in IP packets for transmission in an IP network. More specifically, the MPEG-2 TS standard makes it possible to multiplex one or more programs in a single data stream.

Another compression standard, the MPEG-2 SVC (scalable video coding) compression standard, currently being standardized within the ISO/MPEG standardization group and developed jointly by the MPEG standardization committee and by the ITU (International Telecommunication Union), corresponds to a modification of the MPEG-2 AVC standard which makes it possible to hierarchically code video data.

Such an MPEG-4 SVC coding relies on a layered hierarchical structure. Thus, by virtue of such a coding, an elementary stream can be structured on the one hand as a base stream which corresponds to the base layer of the hierarchical coding, and on the other hand, as one or more enhancement streams corresponding to higher layers of the hierarchical coding. Such a hierarchical structure can be implemented in various dimensions. There is thus provided such a hierarchical structure in a time dimension, in a space dimension or even in a quality dimension.

In such a structure, the data contained in the base stream are sufficient to reconstruct the original video/audio stream on reception, the data transported in the enhancement streams serving to enhance certain aspects of this base stream. These enhancement streams are in fact used to enhance the quality or even the spatial resolution, or the time frequency of the video stream concerned, but they remain optional with respect to the basic data stream enabling it alone to decode and present the transported data.

On the basis of such a hierarchical structure, provision is then made to be able to adapt the duly obtained video stream according to certain constraints relating, for example, to the bandwidth available for transmitting such a stream or even to the capabilities of the stream receiver.

Thus, for example, when the bandwidth is too small to be able to transmit the base stream with the corresponding enhancement streams, it may be advantageous to filter the data of certain enhancement streams to reduce the quantity of data transmitted and thus transmit a quantity of data suited to the available bandwidth.

Provision can here be made to implement the MPEG-4 SVC standard in the encoder 11, in the context of the architecture as illustrated in FIG. 1. In this case, PES packets obtained by application of the MPEG-4 SVC standard can be supplied at the output of the encoder 11, then they can be grouped together in TS packets according to the MPEG-2 TS protocol in the multiplexer 12, before being encapsulated in IP packets in order for them to be transmitted in the IP network.

It should be noted that, since the order in which the TS packets are supplied at the output of the multiplexer 12 is not related to the different stream layers corresponding to the hierarchical structure as defined by the MPEG-4 SVC standard, an IP packet grouping together TS packets may comprise both TS packets of the base stream and TS packets of enhancement streams. Furthermore, TS packets corresponding to the MPEG-4 SVC coding in different dimensions may also be grouped together in one and the same IP packet.

In these conditions, implementing any filtering to address certain constraints, such as, for example, a bandwidth constraint, may prove complex and costly. In practice, each IP packet may here potentially include TS packets of enhancement streams of any layer and coding dimension. Consequently, in order to perform a relevant filtering, it is then necessary to perform a de-encapsulation analysis of each IP packet in order to potentially detect therein TS packets relating to the enhancement data stream that is to be filtered.

The present invention enhances the situation.

A first aspect of the present invention proposes a method for transmission, via a packet transmission network, of a stream of packets to be transmitted from a stream coded hierarchically in the form of a base stream and of at least one enhancement stream in one dimension;

said transmission method comprising the following steps:
/a/ receiving, from an encoder, in the form of a first stream, a first series ordered according to a first order of coded packets relating to both the base stream and the enhancement stream;
/b/ obtaining, in the form of a second stream, a second series of packets coded according to a second order by grouping together said coded packets in groups of N packets, by browsing, in the first order, the coded packets of the first series, said N packets of one and the same group being of one and the same type, either all relating to the base stream or all relating to the enhancement stream, N being an integer number determined according to the transmission network and the size of the coded packets; and
/c/ composing packets to be transmitted, said packets respectively comprising for their payload the groups of N successive packets of the second series of coded packets.

By virtue of these arrangements, the packets to be transmitted are advantageously uniform packets, that is to say, packets that contain only coded packets of one and the same type. A possible stream filtering suited to the hierarchical coding used is then easy to put in place. The transmission method as claimed in claim 1, in which the first series of coded packets is derived from an encoding according to an MPEG-4 SVC-type protocol followed by a multiplexing according to an MPEG-2 TS-type protocol, and the determined transmission protocol is the IP protocol.

The first series of coded packets may be derived from an encoding according to an MPEG-4 SVC-type protocol followed by a multiplexing according to an MPEG-2 TS-type protocol, and the determined transmission protocol may correspond to the IP protocol.

No limitation is attached to the present invention with respect to the method applied for the type of packets to be transmitted to be able to be easily identified during their transmission in the network.

In one embodiment of the present invention, each packet to be transmitted includes an indication of the type of packets that it comprises.

In this case, when the determined transmission method is the IP protocol, the stream indication may correspond to the TOS (type of service) field.

When the determined transmission method is the RTP protocol, the stream indication may correspond to one field out of the SSRC field and the CSRD field.

Provision can also be made for the determined transmission protocol to be the UDP protocol, in which case the packets to be transmitted whose payload is a group of packets relating to the base stream may be transmitted to one and the same first IP address and/or one and the same first port and the packets to be transmitted whose payload is a group of packets relating to the enhancement stream may be transmitted to one and the same second IP address and/or one and the same second port.

All these methods can be used to very easily identify, directly at the level of the transmitted packets, the type of coded packets transported without having to de-encapsulate the transmitted packets.

A second aspect of the present invention proposes a method for adapting transmission, in a packet transmission network, according to a determined transmission protocol, of a video stream coded hierarchically at least in the form of a base stream and of at least one enhancement stream in one dimension; each packet transmitted in the network being obtained by application of a predefined transmission method;

said adaptation method comprising the following steps in an adaptation entity:
/1/ deciding to adapt the transmission of the video stream according to specific criteria; and
/2/ deleting the transmitted packets grouping together coded packets relating to the enhancement stream.

By virtue of these arrangements, it becomes possible to easily and effectively adapt a transmitted stream according to specific constraints directly on the basis of the packets transmitted, since said transmitted packets are uniform in respect of how they belong to a coding layer level.

The specific criteria may correspond to the filtering criteria listed hereinbelow.

Each transmitted packet may advantageously comprise a stream indication relating to the base stream or the enhancement stream to which it belongs, and the step /2/ may then be implemented on the basis of said stream indication.

When the packets to be transmitted whose payload is a group of packets relating to the base stream are transmitted to one and the same first IP address and/or one and the same first port and the packets to be transmitted whose payload is a group of packets relating to the enhancement stream are transmitted to one and the same second IP address and/or one and the same second port, then the step /2/ may advantageously be implemented on the basis of said first and second port and of said first and second IP addresses.

A third aspect of the present invention proposes a transmission entity suitable for implementing the transmission method according to the first aspect of the present invention.

A fourth aspect of the present invention proposes a transmission adaptation entity suitable for implementing the transmission adaptation method according to the second aspect of the present invention.

A fifth aspect of the present invention proposes a system for transmitting a video stream coded hierarchically at least in the form of a base stream and of at least one enhancement stream in one dimension; comprising a transmission entity according to the third aspect of the present invention and an adaptation entity according to the fourth aspect of the present invention.

A sixth aspect of the present invention proposes a computer program comprising instructions for implementing the transmission method according to the first aspect of the present invention, when this program is executed by a processor.

A seventh aspect of the present invention proposes a computer program comprising instructions for implementing the transmission adaptation method according to the second aspect of the present invention, when this program is executed by a processor.

Other aspects, aims and advantages of the invention will become apparent from reading the description of one of its embodiments.

The invention will also be better understood from the drawings, in which:

FIG. 1 illustrates a conventional architecture for the transmission of a video stream coded according to the MPEG-4 AVC protocol and transmitted over IP according to the MPEG-2 TS protocol;

FIG. 2 illustrates the main steps of a method for transmitting a data stream according to one embodiment of the present invention;

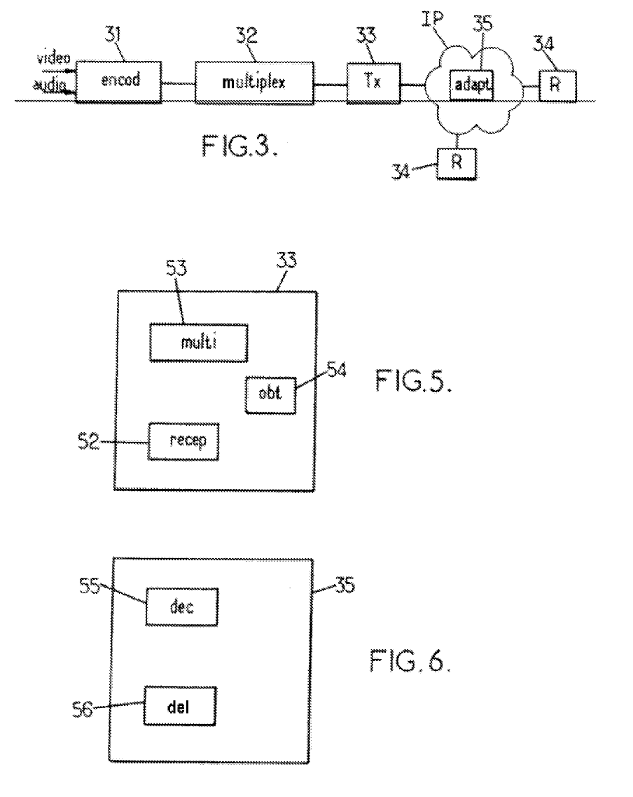

FIG. 3 illustrates an image processing system suitable for the implementation of a transmission method according to one embodiment of the present invention;

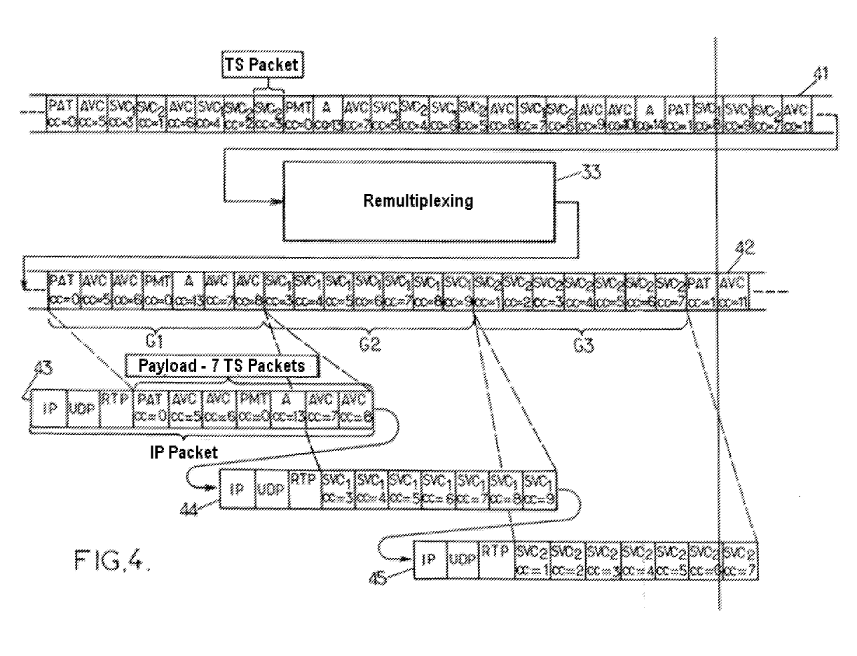

FIG. 4 illustrates the application of a data stream transmission method according to one embodiment of the present invention; and

FIG. 5 illustrates a transmission entity and a transmission adaptation entity according to one embodiment of the present invention.

The present invention is described hereinbelow in its application to the transmission according to an MPEG-2 TS-type protocol over an IP network of data coded according to an MPEG-4 SVC-type coding.

However, this description is given as an illustration and in no way limits other applications of the present invention. It should be noted to this end that one embodiment of the present invention may advantageously be implemented in a transmission of data coded according to hierarchical coding which makes it possible to distinguish basic data and optional data, the basic data being required as a minimum to allow for the transmitted data to be decoded, the optional data complementing these basic data to enhance certain aspects such as the spatial resolution, or the time resolution or even the quality of the decoded transmitted data.

In practice, in the context of a hierarchical data coding, it is advantageous to implement an embodiment of the present invention in order to allow for a simple implementation of a possible filtering of the transmitted data streams obtained by hierarchical coding.

FIG. 2 illustrates the main steps of a method for transmission of a video stream according to one embodiment of the present invention. These steps are implemented after the coding of the data to be transmitted and before the actual transmission of the coded data over the transmission network used for this purpose.

In an exemplary embodiment, the transmission network used is an IP network and the multiplexing of the coded data transmitted over IP is performed according to the MPEG-2 TS protocol.

In a step 21, a first series of coded packets is received, originating from a coding step according to a hierarchical coding protocol, such as, for example, according to the MPEG-4 SVC protocol. Such a coding protocol makes it possible to code data according to a base data stream and one or more enhancement data streams, for each dimension concerned, that is to say, either by quality or by spatial resolution, or even by time resolution.

Consequently, this series of packets comprises packets relating both to the base data stream and to any enhancement data streams. In this first series of packets, these packets are ordered in a first order. This first order does not a priori take into account the type of data stream to which the packets of the first series of packets belong.

In practice, such is the case in particular in an existing data coding architecture based on an MPEG-2 TS-type transmission protocol. Thus, this first series of coded packets may correspond to what is obtained in an architecture as illustrated in FIG. 1 when the encoder applies an MPEG-4 SVC-type coding. In this case, these packets are MPEG-2 TS-type packets.

Thus, on completion of the step 21, a first series of packets ordered in a first order is thus available.

In a step /22/, a second series of coded packets is obtained in a second order. This second series of coded packets is obtained by browsing in the first order the first series of packets and by successively grouping together the packets of this series in uniform groups of packets. The expression “uniform group of packets” should be understood here to mean a group of packets that all relate to one and the same type of coded data stream.

The different stream types correspond in particular to a base stream or even to an enhancement stream of a given level, or to an audio stream.

Thus, packets that belong either to the base data stream or else to one and the same enhancement stream are grouped together in groups of packets, by browsing in the order of the first series of packets.

The packets of the first series that belong neither to a base stream nor to an enhancement stream are associated with the base stream and, consequently, groups together base stream packet groups. Such is the case, for example, for the audio stream packets.

When the hierarchical coding is performed in several dimensions, it should be specified that a uniform group of packets consists of packets that all originate from one and the same stream type, base stream, including audio stream, or enhancement stream, of one and the same layer level and with a coding in one and the same dimension.

There is then obtained a second series of coded packets ordered differently, in which uniform groups of N coded packets follow one another. N is an integer number that is determined according to the size of the coded packets of the first series of packets and according to the size of the packets to be transmitted according to the determined transmission protocol.

Then, in a step 23, packets to be transmitted are composed from the second series of packets. More specifically, these packets to be transmitted are composed according to the transmission protocol used in the transmission network for the streams concerned. The payload of each of these packets to be transmitted consists of a uniform group of packets forming the second series of packets. Successively, the packets to be transmitted are composed with the successive groups of duly formed packets.

FIG. 3 illustrates an architecture suitable for implementing a video stream transmission method according to one embodiment of the present invention.

This architecture relies on an encoder 31 which is responsible for coding audio and video data according to a hierarchical coding protocol such as the MPEG-4 SVC coding protocol. Then, at the output of the encoder, the data are supplied to an MPEG-2 TS-type multiplexer 32. The multiplexed MPEG-2 TS stream at the output of the multiplexer 32 contains elementary video and audio streams. It is possible to adjust by dimension, that is to say for the spatial resolution, or the time frequency, or even the quality, the number of enhancement layers and the configuration of these layers in the encoder 31 according to the video and/or audio application(s) and the transmission context. For example, it is possible to provide for, in order for a video source to be encoded and transmitted in HD format, that is to say, with a high spatial resolution level, on the one hand, a base stream to be encoded corresponding to an MPEG-4 AVC type coding, that is to say, with an SD-type spatial resolution level, and an enhancement layer to be encoded with a high spatial resolution level, in HD format like the corresponding video source.

As for the audio content, this may be encoded in an audio coding format such as the MPEG-2 audio format for example.

This multiplexer 32 is adapted to supply the first series of coded packets.

A video and audio content compressed in this way according to the MPEG-4 SVC protocol may be decoded at different bit rates on the basis of a time scalability, or according to different spatial resolutions on the basis of a spatial scalability, or even according to different quality levels on the basis of a quality scalability.

In an MPEG-4 SVC compressed stream, the base layer for the base streams is compatible with an MPEG-4 AVC/H.264-type coding format.

Such a coded stream consists of a series of access units, or AU, each corresponding to compressed data relating to an image of the video sequence at a given instant. An AU is subdivided into one or more NALU (network abstraction layer units) for management of the packet transmission over the transmission network, thus facilitating the transport mechanisms on this network. The NALUs may be of “data” type, referenced VCL (video coding layer) or of “signaling” type, notably referenced SEI (supplemental enhancement information), SPS (sequence parameter set), or PPS (picture parameter set). Each data NALU therefore corresponds to an image portion.

A NALU header according to the MPEG-4 SVC protocol consists of bytes that notably contain fields indicating a priority level “priority_ID”, a dependency level “dependency_ID”, a time reference “temporal_level”, a quality level “quality_level”. These fields make it possible to identify layer levels and coding dimensions to which an NALU concerned belongs.

More specifically, the “dependency_ID” field, which may take a value of between 0 and 7, can be used to ascertain the spatial resolution level of a hierarchical coding level. This level may also make it possible to control the quality relative to the signal-to-noise ratio, or SNR, or the time adaptation in the context of a layered coding (i.e., for a discrete number of operating points).

The “temporal_level” field can be used to indicate an image frequency. The “quality_level” field indicates a progressive quantization level, and, because of this, can be used to control a bit rate level relative to a quality level and/or a complexity level.

The “layer_base_flag” field indicates a data syntax compatible with an AVC-type coding.

As stated hereinabove, at the encoding output, the elementary streams consist of AUs. Then, the encoded data are placed in PES (packetized elementary stream) packets. A PES packet consists of a header followed by a payload as described hereinabove.

Then, the PES packets of variable size are grouped together in fixed-length TS packets. These TS packets for the different media are then multiplexed and synchronized in a single stream. The TS packets also consist of a header and a payload. The header of a TS packet contains, in particular:
a PID (“packet identifier”) field making it possible to identify the content of the data present in the payload of the packet, one and the same PID value being assigned to packets transporting data deriving from one and the same elementary stream;
a continuity index (continuity_counter or “cc”) making it possible to guarantee a continuity of the data transmitted in the stream; and
an indication field (payload_unit_start_indicator) indicating whether or not the payload contains the start of a PES packet.

The duly obtained stream therefore corresponds to the first series of coded packets.

Then, this stream obtained at the output of the multiplexer 32 is supplied to the input of a transmission entity 33 according to one embodiment of the present invention.

This transmission entity 33 is suitable for performing the step 22 and the step 23 of the method according to one embodiment of the present invention.

Provision can be made for this transmission entity 33 to be located at a gateway responsible for receiving an MPEG-2 TS stream from the multiplexer 32 and transmitting it in the IP network to receivers 34 which are able to process this MPEG-2 TS over IP stream on reception.

A stream of multiplexed coded packets at the output of the multiplexer 32, that is to say, a stream corresponding to the first series of coded packets, may correspond to TS packets deriving from the different multiplexed elementary streams and from the packets indicating tables containing information necessary to be able to demultiplex this received stream. The different tables present in a transport stream to allow for such a demultiplexing may notably be as follows:
a program association table, or PAT, containing, for each program included in the multiplexed stream concerned, a program number and the PID number of the packets transporting the content of a program map table describing the program, these PAT tables generally being transported in the packets having the PID value equal to; or
a program map table, or PMT, containing, for a given program and for each elementary component contained in the program:
   an indication of the type of elementary stream, such as the type of coding (MPEG-2 video, MPEG-2 audio, MPEG-4 AVC);
   the PID number of the packets transporting the data of the elementary stream; and
   optional description data giving additional information concerning the elementary streams.

A PMT table also contains a field indicating the PID number of the packets transporting a time reference.

In an MPEG-2 TS stream, it is possible to have packets belonging to just one program (a single pair (program number, PID number) in the PAT table). In this case, the term SPTS (single program transport stream) applies. It is also possible to have several programs in one and the same TS stream (a number of pairs (program number, PID number) in the PAT table). In this case, the stream contains all the packets of all the programs, and the expression MPTS (multiple program transport stream) applies.

The demultiplexing and decoding of a program consists, for each elementary component, after having identified the PID numbers of these different elementary components, in reconstituting the PES packets transported in the TS packets. The PID field is then used to collect the packets of one and the same elementary stream in order to reconstruct this elementary stream before it is decoded. The continuity counters (“continuity_counter” field) are used to check the integrity of the elementary stream and thus detect any packet losses. The boundaries of the PES packets distributed over the various TS packets of one and the same PID are indicated by the “payload_unit_start_indicator” field.

Then, the AUs present in the payload of the PES packets are extracted. Next, these various AUs are decoded at instants indicated in the headers of the PES packets. The AUs are finally presented at instants that are also indicated in the headers of the PES packets.

Provision can be made, for each AU supplied by an MPEG-4 SVC-type encoder, for the NALUs to be separated according to their layer index “dependency_ID” and encapsulated in PES packets that are distinct but which have the same time stamp values. These packets are then encapsulated in TS packets whose PID value makes it possible to distinguish different elementary substreams deriving from the original MPEG-4 SVC stream.

In one embodiment of the present invention, provision can be made for the scalability layers to be transported in distinct channels (PID) in order to retain compatibility with the receivers and the MPEG-4 AVC demultiplexers which are not suitable for receiving data coded according to MPEG-4 SVC.

Provision can also be made for different scalability layers to be transported in distinct PID channels in order to facilitate the filtering of the enhancement layers which may then be easily based on a filtering of the elementary streams by checking the channel number (PID) in the header of the TS packets.

In an MPEG-2 TS over IP stream as specified by the IETF in RFC2250 (RTP payload format MPEG1/MPEG2 video), the payload of an RTP packet corresponds to an integer number of TS packets. The number of TS packets is determined by the maximum size of an IP frame according to the type of network used beyond which an IP packet is fragmented by network elements during transmission, thus increasing the risk of more significant data losses. For example, for an Ethernet-type network, the number of TS packets included in an RTP packet may be equal to 7.

FIG. 4 illustrates a data stream transmission method according to one embodiment of the present invention applied to a first series of packets coded according to MPEG-4 SVC and multiplexed according to MPEG-2 TS to obtain a second series of packets suitable for a transmission over an IP network, of Ethernet type.

In the example illustrated, the data are coded according to a base stream, whose packets are referenced “AVC”, and the first and second enhancement streams, whose packets are respectively referenced “SVC₁” and “SVC₂”, in a single dimension which can therefore be time, space, or even quality. However, it should be noted that it is easy to extend this illustrated example to data coded according to a base stream and any integer number of enhancement streams by dimension, in a plurality of dimensions, as is possible by the application of an MPEG-4 SVC-type coding.

As illustrated in FIG. 5, a first series of TS packets 41 comprises a first type of TS packets belonging to a base stream, a second type of TS packets belonging to a first enhancement stream and a third type of TS packets belonging to a second enhancement stream. The first type of TS packets may correspond either to a program association table (or PAT) or program map table (PMT), or else to packets referenced AVC since the MPEG-4 AVC coding corresponds to the MPEG-4 SVC coding for the base stream, or also to the packets deriving from the audio-type stream, referenced A.

The second type of TS packets corresponds to the packets referenced SVC₁ and the third type of TS packets corresponds to the packets referenced SVC₂.

By applying a transmission method according to one embodiment of the present invention to this first series of TS packets, a second series of coded packets 52 is obtained.

The example illustrated corresponds to a transmission of data in the RTP packets. Consequently, the number N, as defined previously, is equal to 7. Thus, the TS packets of the first series of coded packets are browsed and, during this browsing, these packets are reordered in another order which makes it possible to obtain uniform successive groups of N coded packets, that is to say groups of packets each comprising coded packets deriving from the same type of stream in the same dimension.

Thus, to form a first group of seven packets G1, the packets of the first series are browsed. The first packet TS is a PAT packet of the first type of packet. Consequently, the group G1 is a group of packets belonging to the base stream and, more generally, of packets belonging to no enhancement stream, such as, for example, packets of an audio stream. Thus, the first group of packets G1 is supplemented by all the packets of the first type which follow the PAT packet in the first series of TS packets 41.

Furthermore, in this example, the different groups of packets are formed by taking into account the value of the continuity field cc indicated in each TS packet of the first series of packets. This field value is used in order to be able to group together TS packets which are not only derived from the same type of stream, but also follow one another.

Thus, G1 also comprises an AVC packet with a continuity field value equal to 5. Then, the packets SVC₁ and SVC₂ which follow this AVC packet are not selected to form part of this group G1 since they are not of the same packet type.

An AVC packet that has a continuity field value equal to 6 is then selected to belong to the group G1. Then, a PMT packet having a continuity field value equal to 0, a packet A deriving from an audio-type stream having a continuity field value equal to 13, an AVC packet having a continuity field value equal to 7, and finally an AVC packet having a continuity field value equal to 8 are finally selected to form part of the group of 7 packets G1.

Then, to form the second group of packets G2, the first series of packets is browsed again from the first packet of the series that was not selected to belong to the first group of packets. In the example illustrated in FIG. 5, the first packet of the second group of packets is a packet of type SVC₁ having a continuity field value equal to 3. Then, the other packets selected to belong to the group G2 are the subsequent packets SVC₁ which have continuity field values which increase in the first series of packets. Thus, the group G2 consists of packets SVC₁ which respectively have cc values equal to 3, 4, 5, 6, 7, 8 and 9.

The third group of packets G3 is formed in the same way. The first packet is the first of the first series not yet selected to belong to a group that has already been formed.

Here, this first packet of the group G3 corresponds to a packet SVC₂ with a continuity field value equal to 1. Then, the six subsequent packets SVC₂ which have increasing continuity field values are then selected from the first series to belong to the group G3. Thus, the group of packets G3 consists of the packets SVC₂ that have continuity field values respectively equal to 1, 2, 4, 5, 6, 7 and 8.

No limitation is attached to the implementation of such a transmission method which aims to remultiplex the TS packets after their processing by an MPEG-2 TS-type encoder.

It is possible in particular to consider implementing this remultiplexing directly at the output of the MPEG-2 TS multiplexer.

When the transmission network comprises an IP gateway which receives an MPEG-2 TS stream and which is responsible for encapsulating it in an IP stream, it may be advantageous to provide for this remultiplexing to be implemented within this IP gateway. Such an IP gateway is then suitable for receiving MPEG-2 TS streams and for encapsulating them in IP streams according to one embodiment of the present invention so as to obtain IP packets that are uniform according to the base and the enhancement streams concerned.

IP packets are therefore obtained in which the payload consists of a group of uniform packets according to one embodiment of the present invention. A first IP packet (RTP) 43, which has for its payload the first group of packets, a second IP packet (RTP) 44, which has for its payload the second group of packets, and a third IP packet (RTP) 45, which has for its payload the third group of packets, are obtained here.

It is possible advantageously to provide for the header of each IP packet to indicate the coding layer to which it belongs. Such an indication subsequently makes it possible to simply put in place a filtering on the type of SVC stream.

No limitation is attached to the method used for duly marking these IP packets obtained according to one embodiment of the present invention. To this end, it is notably possible to provide for a field allowing for IP packets to be classified, such as the TOS (type of service) field, to be used.

It is also easily possible to provide for the different types of IP packets to be distinguished on the basis of different respective UDP addresses and/or on the basis of different broadcast ports. Thus, all the IP packets of one and the same type may be transmitted to one and the same IP address and/or one and the same IP port, this same IP address and/or this same IP port being different according to the type of IP packets.

It is also easy to provide for an indication, for each IP packet, of the type to which it belongs by using a field present in the header of the RTP packets, such as the SSRC or CSRC fields.

By thus marking the IP packets which cross the network, it is easily possible to implement a filtering of the data without having to extract and analyze the different MPEG-2 TS packets contained in the payload of the IP packets.

In order to be able to adapt the transmission data stream by the transmission entity according to one embodiment of the present invention, an adaptation entity 35 must be provided which is suitable for filtering the data, or packets, transmitted in the IP network on the basis of the types of stream to which they belong. This adaptation entity may be located at any point in the transmission network between the transmission entity and the receiver to which the stream is addressed.

More specifically, this adaptation entity is responsible for filtering TS packets according to one embodiment based on how they belong to the various elementary base or enhancement streams and according to various constraints and filtering criteria such as the available bandwidth, or the capabilities of the terminal, or even the content access rights of a user of the terminal.

Thus, for example, an MPEG-2 TS-type stream transmitted according to one embodiment of the present invention may be encoded at a bit rate of 6 Mb/s, whereas the available bandwidth between the adaptation entity 35 and the final receiver 34 is only 4 Mb/s. In this case, provision is made, at the adaptation entity 35, to filter the stream concerned so as to delete TS packets belonging to the enhancement stream which corresponds, for example, to the high level spatial resolution content and to send only the TS packets that make it possible to reconstruct and decode the base stream corresponding to the base level resolution content, encoded at a bit rate below 4 Mb/s.

The adaptation entity 35 performs a filtering based on the type of marking used to indicate a packet type for each IP packet of the stream concerned.

Thus, when the marking of the IP packet type is based on the use of the TOS field in the IP packets, the filtering performed at the adaptation module relies on checking the value of this field in the IP packets of the stream concerned. It is thus possible to consider deleting all the IP packets for which the TOS field value is greater than that which corresponds to the base stream.

When the marking of the IP packet type is based on the UDP protocol and, more specifically, on the use of certain ports respectively for the different types of packets, it is possible to consider filtering, at the adaptation module, all the UDP packets broadcast to port numbers higher than that on which the base stream is broadcast, in order to transmit only the UDP packets of the base stream.

In the case where the marking of the IP packet type relies on the use of the SSRC fields in a stream of RTP packets, it is possible to provide, at the adaptation module, for the MPEG-2 TS stream to be filtered by deleting all the RTP packets that have an SSRC field value greater than that contained in the RTP packets of the base stream.

Thus, the receiver will receive only an IP packet at a bit rate below the available bandwidth, containing the TS packets that can be used to decode the base stream.

FIG. 5 illustrates a transmission entity 33 according to one embodiment of the present invention. It comprises:
a reception unit 52 suitable for receiving, from an encoder, a first series ordered according to a first order of coded packets relative both to the base stream and to the enhancement stream;
a re-multiplexing unit 53 suitable for obtaining a second series of packets coded according to a second order by grouping together said coded packets in groups of N packets, by browsing in the first order the coded packets of the first series, said N packets of one and the same group either all relating to the base stream or all relating to the enhancement stream, N being an integer number determined according to the transmission network and the size of the coded packets; and
a unit 54 for obtaining packets to be transmitted suitable for composing packets to be transmitted according to the determined transmission protocol, said packets respectively comprising, as their payload, the groups of N successive packets of the second series of coded packets.

FIG. 5 also illustrates a transmission adaptation entity 35 according to one embodiment of the present invention. It comprises:
a decision unit 55 suitable for deciding to adapt the transmission of the video stream according to specific criteria; and
a filtering unit 56 suitable for deleting the transmitted packets grouping together coded packets relating to the enhancement stream.

When each transmitted packet includes a stream indication relating to the base stream or to the enhancement stream to which it belongs, the filtering unit 52 may then be based on said stream indication.

Then, when the packets to be transmitted whose payload is a group of packets relating to the base stream are transmitted to one and the same first IP address and/or one and the same first port and the packets to be transmitted whose payload is a group of packets relating to the enhancement stream are transmitted to one and the same second IP address and/or one and the same second port, the filtering unit 52 may then be based on said first and second ports and said first and second IP addresses.

1. A method for transmission, via a packet transmission network, of a stream of packets to be transmitted from a stream coded hierarchically in the form of a base stream and of at least one enhancement stream in one dimension; said transmission method comprising the following steps:
/a/ receiving, from an encoder, in the form of a first stream, a first series ordered according to a first order of coded packets relating to both the base stream and the enhancement stream;
/b/ obtaining, in the form of a second stream, a second series of packets coded according to a second order by grouping together said coded packets in groups of N packets, by browsing, in the first order, the coded packets of the first series, said N packets of one and the same group being of one and the same type, either all relating to the base stream or all relating to the enhancement stream, N being an integer number determined according to the transmission network and the size of the coded packets; and
/c/ composing packets to be transmitted, said packets respectively comprising for their payload the groups of N successive packets of the second series of coded packets.

2. The transmission method as claimed in claim 1, wherein the first stream is obtained by application of an MPEG-2 TS-type multiplexing.

3. The transmission method as claimed in claim 1, wherein each packet to be transmitted includes an indication of the type of packets that it comprises.

4. The transmission method as claimed in claim 1, wherein the transmission network is based on the UDP protocol, and wherein the packets to be transmitted grouping together packets of one and the same type are transmitted to one and the same IP address.

5. A method for adapting transmission, via a packet transmission network, of a stream of packets to be transmitted, said stream relating to different types;
each packet transmitted in the network being obtained by application of the transmission method as claimed in claim 1;
said adaptation method comprising the following steps:
/1/ deciding to adapt the transmission of the video stream according to specific criteria; and
/2/ deleting the transmitted packets of at least one determined type.

6. The transmission adaptation method as claimed in claim 5, wherein each transmitted packet includes an indication of the type of packets that it comprises; and
wherein the step /2/ is implemented on a basis of said indication of the type of packets.

7. The transmission adaptation method as claimed in claim 5, wherein the packets to be transmitted grouping together packets relating to one and the same type are transmitted to one and the same IP address, and wherein the step /2/ is implemented on a basis of the address of the transmitted packets.

8. A transmission entity suitable for implementing a transmission method as claimed in claim 1.

9. A transmission adaptation entity suitable for implementing the transmission adaptation method as claimed in claim 5.

10. The adaptation entity as claimed in claim 9, wherein, each transmitted packet comprising an indication of the type of packets, the filtering unit is based on said indication.

11. The adaptation entity as claimed in claim 9, wherein, the packets to be transmitted grouping together packets relating to one and the same type are transmitted to one and the same IP address, the filtering unit is based on the address of the transmitted packets.

12. A system for transmitting a stream of packets via a transmission network, comprising the transmission entity as claimed in claim 8 and an adaptation entity suitable for implementing a transmission adaptation method for adapting transmission, via a packet transmission network of a stream of packets to be transmitted, said stream relating to different types;
each packet transmitted in the network being obtained by application of a transmission method, via a packet transmission network, of a stream of packets to be transmitted from a stream coded hierarchically in the form of a base stream and of at least one enhancement stream in one dimension;
said transmission method comprising the following steps:
/a/ receiving, from an encoder, in the form of a first stream, a first series ordered according to a first order of coded packets relating to both the base stream and the enhancement stream;
/b/ obtaining, in the form of a second stream, a second series of packets coded according to a second order by grouping together said coded packets in groups of N packets, by browsing, in the first order, the coded packets of the first series, said N packets of one and the same group being of one and the same type, either all relating to the base stream or all relating to the enhancement stream, N being an integer number determined according to the transmission network and the size of the coded packets; and
/c/ composing packets to be transmitted, said packets respectively comprising for their payload the groups of N successive packets of the second series of coded packets. said adaptation method comprising the following steps:
/1/ deciding to adapt the transmission of the video stream according to specific criteria; and
/2/ deleting the transmitted packets of at least one determined type.

13. A non-transitory computer-readable storage medium storing a computer program comprising instructions for implementing the transmission method as claimed in claim 1, when this program is executed by a processor.

14. A non-transitory computer-readable storage medium storing a computer program comprising instructions for implementing the transmission adaptation method as claimed in claim 5, when this program is executed by a processor.

15. The transmission method as claimed in claim 1, wherein the transmission network is based on the UDP protocol, and wherein the packets to be transmitted grouping together packets of one and the same type are transmitted to one and the same port.

16. The transmission adaptation method as claimed in claim 5, wherein the packets to be transmitted grouping together packets relating to one and the same type are transmitted to one and the same port, and wherein the step /2/ is implemented on a basis of the port of the transmitted packets.

17. The adaptation entity as claimed in claim 9, wherein, the packets to be transmitted grouping together packets relating to one and the same type are transmitted to one and the same port, the filtering unit is based on the port of the transmitted packets.
